(19) United States
(12) Patent Application Publication
(10) Pub. No.: US 2023/0187682 A1
(43) Pub. Date: Jun. 15, 2023

(54) LITHIUM-ION BATTERY AND METHOD FOR MANUFACTURING LITHIUM-ION BATTERY

(71) Applicants: PRIMEARTH EV ENERGY CO., LTD, Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Junya HISHII, Kosai-shi (JP); Takaaki IZUMOTO, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/076,093

(22) Filed: Dec. 6, 2022

(30) Foreign Application Priority Data
Dec. 10, 2021 (JP) 2021-200695

(51) Int. Cl. H01M 10/04; H01M 10/0525; H01M 50/46; H01M 4/04; H01M 50/172; H01M 50/552

(52) U.S. Cl. CPC H01M 10/0431; H01M 10/0525; H01M 50/46; H01M 4/0404; H01M 10/0481; H01M 50/172; H01M 50/552

(57) ABSTRACT

A lithium-ion battery includes a roll formed by rolling a stack of a negative electrode plate, separator, and positive electrode plate in a rolling direction into a flattened form. A negative electrode collector portion formed at one roll end where the negative electrode mixture layer is not applied to two opposite surfaces of the negative electrode substrate layer has an undulated form. The negative electrode substrate layer has two opposite surfaces that are less the negative electrode mixture layer at the end of the roll. A positive electrode collector portion formed at the other roll end where the positive electrode mixture layer is not applied to two opposite surfaces of the positive electrode substrate layer has an undulated form. The positive electrode substrate layer has two opposite surfaces that are less the positive electrode mixture layer at the other roll end.

### BACKGROUND

### 1. Field

The present disclosure relates to a lithium-ion battery including a roll formed by rolling a stack of a positive electrode plate, a separator, and a negative electrode plate and to a method for manufacturing a lithium-ion battery.

### 2. Description of Related Art

Japanese Laid-Open Patent Publication No. 2018-56482 describes a rechargeable battery including a stack of an anode, a separator, and a cathode. The stack is rolled to form a round capacitor in the rechargeable battery. The anode is one example of a negative electrode plate. The cathode is one example of a positive electrode plate. The round capacitor is one example of a roll.

### SUMMARY

An organic solvent, in which a lithium salt is dissolved, is used as an electrolyte in a lithium-ion battery. Thus, the electrolyte has high ion conductivity. During charging, lithium ions are released from the positive electrode, moved through the electrolyte to the negative electrode, and occluded in the negative electrode. This expands the roll. During discharging, lithium ions are released from the negative electrode, moved through the electrolyte to the positive electrode, and occluded in the positive electrode. This contracts the roll.

During high-rate charging or discharging that instantaneously charges or discharges a large current, a vast amount of lithium ions have to be instantaneously occluded and discharged between electrodes. Thus, when charging and discharging are repeated, the roll greatly expands and contracts repeatedly. During charging, lithium ions at the negative electrode side are occluded in the negative electrode. During discharging, lithium ions at the positive electrode side are occluded in the positive electrode. This decreases the lithium salt concentration in the electrolyte at the ends of the roll located at the negative and positive electrode sides. When the roll is greatly expanded or contracted, the electrolyte having the decreased lithium salt concentration is forced out of the roll from the ends at the negative and positive electrode sides. When the roll is shaped to have a fattened form, there is a tendency for the movement smoothness of the electrolyte to differ between the middle of the roll and the ends of the roll. This produces a difference in the lithium salt concentration of the electrolytic solution between the middle of the roll and the ends of the roll. As a result, the internal resistance increases during discharging and adversely affects the battery performance of the lithium-ion battery.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a lithium-ion battery including a roll forming an electrode body. The roll includes a negative electrode plate, a positive electrode plate, and a separator. The negative electrode plate includes a negative electrode substrate layer that is a substrate of a negative electrode and a negative electrode mixture layer arranged on the negative electrode substrate layer. The positive electrode plate includes a positive electrode substrate layer that is a substrate of a positive electrode and a positive electrode mixture layer arranged on the positive electrode substrate layer. The separator is arranged between the negative electrode plate and the positive electrode plate. The roll is formed by rolling a stack of the negative electrode plate, the separator, and the positive electrode plate in a rolling direction. The roll is pressed in a direction orthogonal to an axial direction when rolled to be shaped in a flattened form. The roll includes a negative electrode collector portion at one end of the roll in the axial direction where the negative electrode mixture layer is not applied to two opposite surfaces of the negative electrode substrate layer. The negative electrode collector portion has an undulated form in which a thickness direction of the negative electrode substrate layer corresponds to an amplitude direction and the rolling direction corresponds to a wavelength direction. The roll further includes a positive electrode collector portion at the other end of the roll in the axial direction where the positive electrode mixture layer is not applied to two opposite surfaces of the positive electrode substrate layer. The positive electrode collector portion has an undulated form in which a thickness direction of the positive electrode substrate layer corresponds to an amplitude direction and the rolling direction corresponds to a wavelength direction.

In the above structure, the undulated form is shaped to have an amplitude that decreases as the negative electrode mixture layer or the positive electrode mixture layer becomes closer, and the undulated form is shaped to have an amplitude that increases as the negative electrode mixture layer or the positive electrode mixture layer becomes farther.

In the above structure, the negative electrode collector portion and the positive electrode collector portion are connected by a connector to an external terminal of the lithium-ion battery above a flat portion of the flattened form, and the undulated form of each of the negative electrode collector portion and the positive electrode collector portion are located downward from a lower end of the connector.

In the above structure, in a flat portion of the flattened form of the negative electrode collector portion, two negative electrode substrate layers that are adjacent to each other in a thickness direction of the negative electrode substrate layer of the roll both have the undulated form so that a gap between the two negative electrode substrate layers is located at a position that varies in the thickness direction of the negative electrode substrate layer. Further, in a flat portion of the flattened form of the positive electrode collector portion, two positive electrode substrate layers that are adjacent to each other in a thickness direction of the positive electrode substrate layer of the roll both have the undulated form so that a gap between the two positive electrode substrate layers is located at a position that varies in the thickness direction of the positive electrode substrate layer.

In the above structure, in a flat portion of the flattened form of the negative electrode collector portion, a gap between two negative electrode substrate layers that are adjacent to each other in a thickness direction of the negative electrode substrate layer of the roll has a dimension of 18 μm or less extends at a certain location between the two negative electrode substrate layers. Further, in a flat portion of the flattened form of the positive electrode collector portion, a gap between two positive electrode substrate layers that are adjacent to each other in a thickness direction of the positive electrode substrate layer of the roll has a dimension of 18 μm or less extends at a certain location between the two positive electrode substrate layers.

A further aspect of the present disclosure is a method for manufacturing a lithium-ion battery. The method includes applying a mixture layer to an electrode plate, drying the mixture layer, pressing the electrode plate to adjust its thickness, rolling a stack of a negative electrode plate that is the electrode plate, a separator, and a positive electrode plate that is the electrode plate to form a roll, and flat-pressing the roll in a direction orthogonal to an axial direction in which the rolling is performed so as to press and shape the roll. The applying a mixture layer includes forming an uncoated portion where the mixture layer is not applied at one or two widthwise ends of a coated portion where the mixture layer is applied. The pressing the electrode plate includes setting a value of a first pressure applied to the coated portion and a value of a second pressure applied to the uncoated portion so that an elongated amount of the uncoated portion in a longitudinal direction becomes greater than an elongated amount of the coated portion in the longitudinal direction.

In the above method, the rolling a stack includes setting tension applied to the negative electrode plate and the positive electrode plate when forming the roll so that the uncoated portion and the coated portion have the same lengths in a longitudinal direction.

In the above method, in the pressing the electrode plate, the value of the second pressure applied to the uncoated portion value is 1.2 times greater than the value of the first pressure applied to the coated portion.

Other features and aspects will be apparent from the following detailed description, the drawings, and the claims.

### BRIEF DESCRIPTION OF THE DRAWINGS

FIG. 1 is a perspective view showing one embodiment of a lithium-ion battery.

FIG. 2 is a schematic view showing a stack structure of a roll.

FIG. 3 is a schematic view showing the form of one end of the roll.

FIG. 4 is a schematic enlarged view of portion A illustrated in FIG. 3.

FIG. 5 is a schematic cross-sectional view taken along line 5-5 in FIG. 4 showing gaps between substrate layers.

FIG. 6 is a cross-sectional view taken along line 6-6 in FIG. 4 showing the undulated form of the substrate layers.

FIG. 7 is a cross-sectional view taken along line 7-7 in FIG. 4 showing the undulated form of the substrate layers.

FIG. 8 is a flowchart illustrating a process for producing an electrode plate.

FIG. 9 is a flowchart illustrating a process for assembling a cell.

FIG. 10 is a schematic cross-sectional view illustrating pressing of the electrode plate from two opposite sides.

FIG. 11 is a schematic diagram illustrating the electrode plate subsequent to a pressing step.

FIG. 12 is a schematic diagram illustrating the electrode plate subsequent to a slitting step.

FIG. 13 is a schematic diagram illustrating the electrode plate when applying tension in a rolling step.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

A lithium-ion battery 11 in accordance with the present embodiment will first be described.

Structure of Lithium-Ion Battery

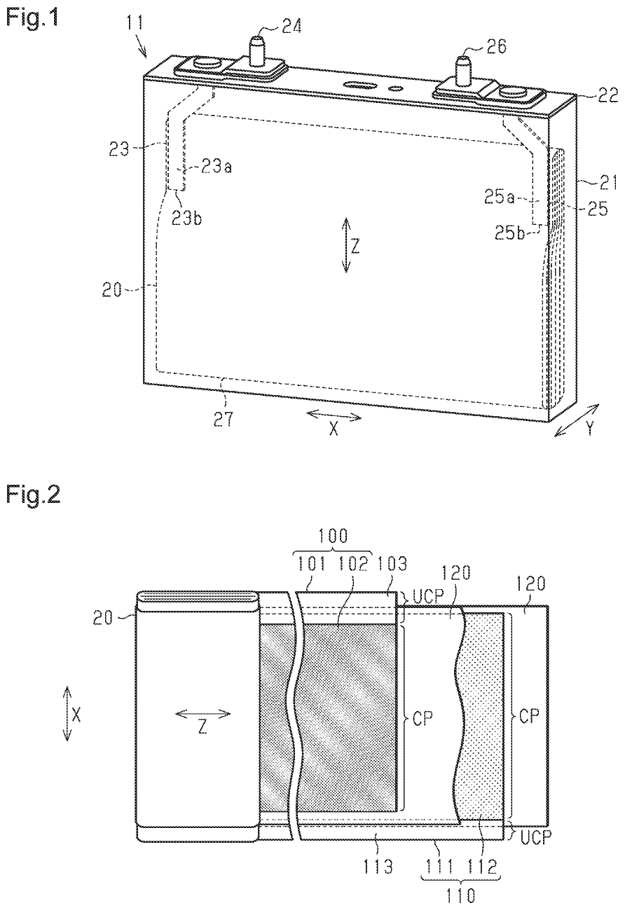

Referring to FIG. 1, the lithium-ion battery 11 is formed as a cell. A number of such cells are connected to form a battery. The lithium-ion battery 11 includes a battery case 21, which is box-shaped and includes an open portion.

A lid 22 closes the open portion of the battery case 21. Attachment of the lid 22 to the battery case 21 forms a sealed battery jar in the lithium-ion battery 11. The battery case 21 and the lid 22 are formed from a metal such as an aluminum alloy.

The lithium-ion battery 11 includes a roll 20 that forms an electrode body. That is, the lithium-ion battery 11 includes the roll 20 that is an electrode body. The battery case 21 contains an electrolyte 27 together with the roll 20. The lithium-ion battery 11 includes a negative electrode external terminal 24 and a positive electrode external terminal 26 on the lid 22 that are used for charging and discharging. FIG. 1 illustrates one example of a terminal form with the negative electrode external terminal 24 and the positive electrode external terminal 26. That is, the forms of the negative electrode external terminal 24 and the positive electrode external terminal 26 are not limited to the shapes illustrated in FIG. 1.

Structure of Roll

As shown in FIG. 2, the roll 20 includes a negative electrode plate 100, a positive electrode plate 110, and a separator 120 arranged between the negative electrode plate 100 and the positive electrode plate 110. The separator 120 insulates electrode plates from each other and holds the electrolyte 27. The negative electrode plate 100, the separator 120, and the positive electrode plate 110 are formed in strips. A stack of the negative electrode plate 100, the separator 120, and the positive electrode plate 110 is rolled in a rolling direction Z to form the roll 20. More specifically, a stack of the separator 120, the positive electrode plate 110, the separator 120, and the negative electrode plate 100, which are stacked in this order, is rolled in the rolling direction Z to form the roll 20 shaped to have a flattened form. The rolling direction Z corresponds to the longitudinal direction of the strip forming each layer. Thus, the rolling direction Z is also referred to as the longitudinal direction Z.

The negative electrode plate 100 includes a negative electrode substrate layer 101, which is the substrate of the negative electrode, and a negative electrode mixture layer 102, which is applied to the two opposite surfaces of the negative electrode substrate layer 101. The roll 20 includes a negative electrode collector portion 103 at one end in an axial direction X of the roll 20. The axial direction X is the direction of a rolling axis when rolling the negative electrode plate 100 in the rolling direction Z during a rolling step in the manufacturing process. The negative electrode collector portion 103 is a portion where the negative electrode mixture layer 102 is not applied to two opposite surfaces of the negative electrode substrate layer 101. The negative electrode collector portion 103 is where electric current flows out from the negative electrode mixture layer 102 of the negative electrode plate 100. The axial direction X corresponds to a widthwise direction, or transverse direction, of the strip forming each layer. Thus, the axial direction X is also referred to as the widthwise direction X.

The portion where the negative electrode mixture layers 102 are applied to the two opposite surfaces of the negative electrode substrate layer 101 corresponds to a portion where the negative electrode mixture layers 102 are applied in an applying step of the manufacturing process and referred to as the coated portion CP. The portion where the negative electrode mixture layers 102 are not applied to the two opposite surfaces of the negative electrode substrate layer 101 corresponds to a portion where the negative electrode mixture layers 102 are not applied in the applying step of the manufacturing process and is referred to as the uncoated portion UCP. The uncoated portion UCP, which is the portion where the negative electrode mixture layer 102 is not applied to the two opposite surfaces of the negative electrode substrate layer 101, is a portion where the two opposite surfaces of the negative electrode substrate layer 101 are exposed.

A copper foil, for example, is used as the negative electrode substrate layer 101. The negative electrode substrate layer 101 has a thickness of approximately 10 pm so that electric current flows to the negative electrode mixture layer 102. Graphite is used for the negative electrode mixture layer 102. Graphite is a material having a crystalline structure of carbon layer stacking, with lithium intercalated between carbon layers.

The positive electrode plate 110 includes a positive electrode substrate layer 111, which is the substrate of the positive electrode, and a positive electrode mixture layer 112, which is applied to the two opposite surfaces of the positive electrode substrate layer 111. The roll 20 includes a positive electrode collector portion 113 at the end of the roll 20 opposite the negative electrode collector portion 103 in the axial direction X. The positive electrode collector portion 113 is a portion where the positive electrode mixture layer 112 is not applied to two opposite surfaces of the positive electrode substrate layer 111. The positive electrode collector portion 113 is where current flows out from the positive electrode mixture layer 112 of the positive electrode plate 110.

The portion where the positive electrode mixture layers 112 are applied to the two opposite surfaces of the positive electrode substrate layer 111 corresponds to a portion where the positive electrode mixture layers 112 are applied in an applying step of the manufacturing process and referred to as the coated portion CP. The portion where the positive electrode mixture layers 112 are not applied to the opposite surfaces of the positive electrode substrate layer 111 corresponds to a portion where the positive electrode mixture layer 112 is not applied in the applying step of the manufacturing process and referred to as the uncoated portion UCP. The uncoated portion UCP, which is the portion where the positive electrode substrate layers 111 are not applied to the two opposite surfaces of the positive electrode mixture layer 112, is a portion where the two opposite surfaces of the positive electrode substrate layer 111 are exposed.

A copper foil, for example, is used as the positive electrode substrate layer 111. The positive electrode substrate layer 111 has a thickness of approximately 15 pm so that electric current flows to the positive electrode mixture layer 112. A mixture of an active material and a conductive material is used for the positive electrode mixture layer 112. The active material is a metal oxide includes a lithium. The active material releases lithium ions during charging and occludes lithium ions during discharging. The conductive material includes carbon nanoparticles. The conductive material contacts the active material and forms an electric path.

The separator 120 is a resin sheet having a thickness of approximately 20 pm. The separator 120 prevents contact between the positive electrode and the negative electrode and includes many fine pores that contain the electrolyte 27.

End Form of Roll

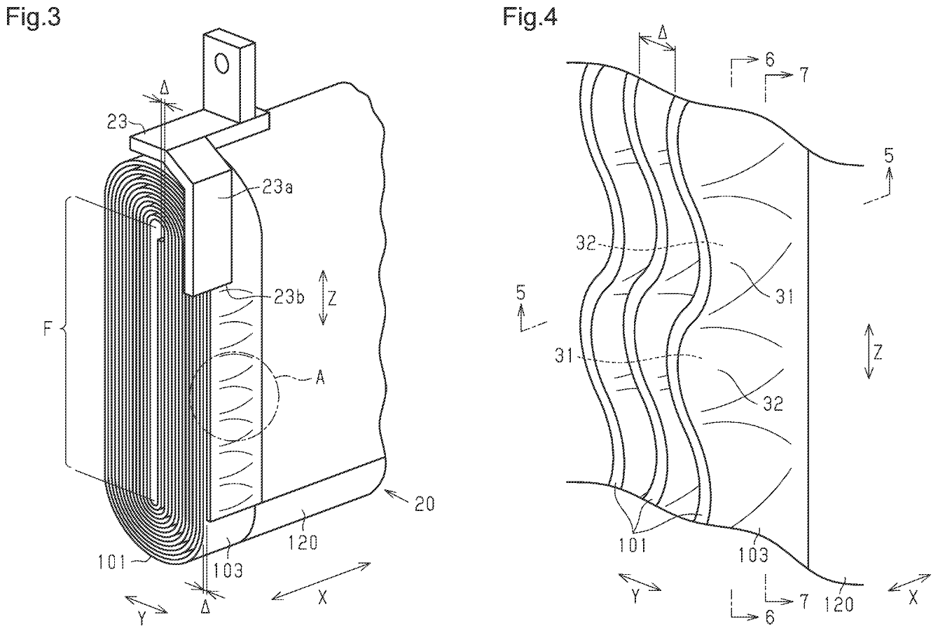

As shown in FIG. 3, the roll 20 is pressed in a thickness direction Y, which is a direction orthogonal to the axial direction X and the rolling direction Z when rolled, to be shaped into a flattened form. The flattened form of the roll 20 includes a flat portion F defined by the two sides in the thickness direction Y.

A negative electrode collector 23 is welded to the negative electrode collector portion 103, which is located at one end of the roll 20 in the axial direction X. More specifically, the negative electrode collector 23 is welded to the negative electrode collector portion 103 above the flat portion F defined by the two sides in the thickness direction Y of the flattened portion. This connects the negative electrode collector portion 103 to the negative electrode external terminal 24, which is an external terminal of the lithium-ion battery 11, with a connector 23a. In one example, the negative electrode collector portion 103 is connected via the negative electrode collector 23 to the negative electrode external terminal 24, and the negative electrode collector 23 can include the connector 23a welded to the negative electrode collector portion 103. In one example, the connector 23a of the negative electrode collector 23 may be an elongated plate. The word “above” as used in this specification indicates the direction toward the trailing side of the roll 20 when arranging it in the battery case 21. Further, the word “below” as used in this specification indicates the direction toward the leading side of the roll 20 when arranging it in the battery case 21.

To facilitate illustration, the negative electrode collector 23 is shown overlapping the negative electrode collector portion 103 only partially in the axial direction X. Actually, the negative electrode collector 23 is welded to and entirely overlaps the negative electrode collector portion 103 in the axial direction X.

A positive electrode collector 25, shown in FIG. 1, is welded to the positive electrode collector portion 113, which is located at the other end of the roll 20 in the axial direction X. More specifically, the positive electrode collector 25 is welded to the positive electrode collector portion 113 above the flat portion F defined by the two sides in the thickness direction Y of the flattened portion. This connects the positive electrode collector portion 113 to the positive electrode external terminal 26, which is an external terminal of the lithium-ion battery 11, with a connector 25a shown in FIG. 1. In one example, the positive electrode collector portion 113 is connected via the positive electrode collector 25 to the positive electrode external terminal 26, and the positive electrode collector 25 can include the connector 25a welded to the positive electrode collector portion 113. In one example, the connector 25a of the positive electrode collector 25 may be an elongated plate.

Undulated Form of Collector Portion

As shown in FIG. 4, at one end of the roll 20, the negative electrode collector portion 103 has an undulated form. In FIG. 3, the undulated form is illustrated by fine solid lines to schematically show how the end of the roll 20 is shaped. In the undulated form of negative electrode collector portion 103, the thickness direction Y of the negative electrode substrate layer 101 corresponds to an amplitude direction, and the rolling direction Z corresponds to a wavelength direction.

In the same manner, at the other end of the roll 20, the positive electrode collector portion 113 has an undulated form. In the undulated form of the positive electrode collector portion 113, the thickness direction Y of the positive electrode substrate layer 111 corresponds to an amplitude direction, and the rolling direction Z corresponds to a wavelength direction.

The undulated form includes crests 31 and troughs 32. More specifically, the undulated form is shaped by the crests 31 and the troughs 32 that are alternately arranged in the surfaces of the substrate layers 101 and 111 without substantially changing the thicknesses of the substrate layers 101 and 111. The crests 31 are peak portions formed in the outer surfaces of the substrate layers 101 and 111, and the troughs 32 are valley portions formed in the outer surfaces of the substrate layers 101 and 111. The collector portions 103 and 113 are in the form of foils. Thus, the inner sides of the crests 31 are the troughs 32. When a crest 31 is arranged in the moving direction of the electrolyte 27, the crest 31 deflects the flow and produces resistance. Thus, the movement of the electrolyte 27 is hindered in the direction in which the crests 31 are arranged.

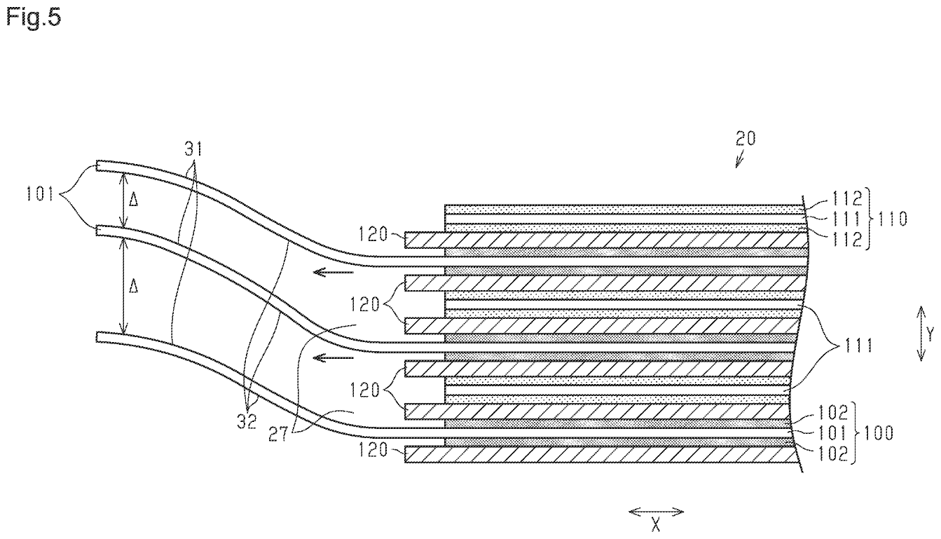

As shown in FIG. 5, the roll 20 is formed by stacking the separator 120, the negative electrode plate 100, the separator 120, and the positive electrode plate 110 in this order. Thus, in the negative electrode collector portion 103, the thickness of the two separators 120 and the single positive electrode plate 110 located between two negative electrode plates 100 and the thickness of two negative electrode mixture layers 102 forms a gap Δ between two adjacent ones of the negative electrode substrate layer 101.

In the negative electrode collector portion 103 of the roll 20 having such a layer structure, the negative electrode substrate layer 101 undulates in the thickness direction Y so that the negative electrode collector portion 103 has an undulated form. More specifically, in the flat portion F of the flattened form of the negative electrode collector portion 103 shown in FIG. 3, two of the negative electrode substrate layers 101 adjacent to each other in the thickness direction Y of the negative electrode substrate layer 101 both have an undulated form. As a result, the gap Δ between the two negative electrode substrate layers 101 is located at a position that varies in the thickness direction Y of the negative electrode substrate layer 101.

In the same manner, in the positive electrode collector portion 113, the thickness of the two separators 120 and the single negative electrode plate 100 located between two positive electrode plates 110 and the thickness of two positive electrode mixture material layer 112 forms a gap Δ between two adjacent ones of the positive electrode substrate layers 111.

In the positive electrode collector portion 113 of the roll 20 having such a layer structure, the positive electrode substrate layer 111 undulates in the thickness direction Y so that the positive electrode collector portion 113 has an undulated form. More specifically, in the flat portion F of the flattened form of the positive electrode collector portion 113, two of the positive electrode substrate layers 111 adjacent to each other in the thickness direction Y of the positive electrode substrate layer 111 both have an undulated form. As a result, the gap A between the two positive electrode substrate layers 111 is located at a position that varies in the thickness direction Y of the positive electrode substrate layer 111.

When performing welding, the thickness of the roll 20 in the thickness direction Y of the roll 20 is reduced at the portion where the connector 23a shown in FIG. 1 is welded to the negative electrode collector portion 103 and at the portion where the connector 25a is welded to the positive electrode collector portion 113. More specifically, two adjacent ones of the negative electrode substrate layers 101 at the welded portion come into contact with each other when welding is performed such that the dimension of the gap Δ at the connector 23a becomes substantially null. Further, two adjacent ones of the positive electrode substrate layers 111 at the welded portion come into contact with each other when welding is performed such that the dimension of the gap Δ at the connector 25a becomes substantially null. Thus, the negative electrode collector portion 103 may have the undulated form below the lower end 23b of the connector 23a. Further, the positive electrode collector portion 113 may have the undulated form below the lower end 25b of the connector 25a.

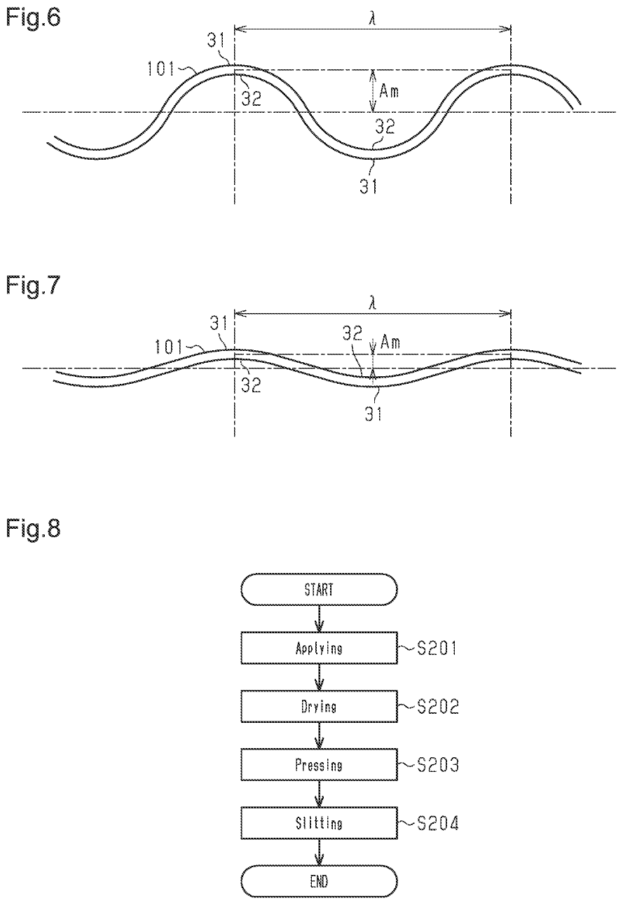

As shown in FIG. 6, in the negative electrode collector portion 103, the amplitude Am of the undulated form is large at an area far from the negative electrode mixture layer 102. In the same manner, in the positive electrode collector portion 113, the amplitude Am of the undulated form is large at an area far from the positive electrode mixture material layer 112.

As shown in FIG. 7, in the negative electrode collector portion 103, the amplitude Am of the undulated form is small at an area close to the negative electrode mixture layer 102. In the same manner, in the positive electrode collector portion 113, the amplitude Am of the undulated form is small at an area close to the positive electrode mixture material layer 112.

Accordingly, the undulated form is shaped so that the amplitude Am decreases as the negative electrode mixture layer 102 becomes closer and so that the amplitude Am increases as the negative electrode mixture layer 102 becomes farther. Further, the undulated form is shaped so that the amplitude Am decreases as the positive electrode mixture material layer 112 becomes closer and so that the amplitude Am increases as the positive electrode mixture material layer 112 becomes farther. In other words, the undulated form is shaped so that the amplitude Am decreases as the negative electrode mixture layer 102 or the positive electrode mixture material layer 112 becomes closer and so that the amplitude Am increases as the negative electrode mixture layer 102 or the positive electrode mixture material layer 112 becomes farther.

In the present embodiment, the undulated form is shaped so that the amplitude Am gradually decreases as the negative electrode mixture layer 102 becomes closer and so that the amplitude Am becomes null before reaching the negative electrode mixture layer 102. Further, the undulated form is shaped so that the amplitude Am gradually decreases as the positive electrode mixture material layer 112 becomes closer and so that the amplitude Am becomes null before reaching the positive electrode mixture material layer 112.

The portion of the negative electrode plate 100 where the negative electrode mixture layer 102 is arranged may be somewhat curved. For example, when the amplitude Am does not become null before reaching the negative electrode mixture layer 102 and the portion where the negative electrode mixture layer 102 is arranged is slightly curved, the undulated form may be shaped so that the amplitude Am becomes null after reaching the negative electrode mixture layer 102. Slightly curved as used in this specification means the collector portions 103 and 113 being curved so as to have a smaller amplitude than the amplitude Am.

In the same manner, the portion of the positive electrode plate 110 where the positive electrode mixture material layer 112 is arranged may be somewhat curved. For example, when the amplitude Am does not become null before reaching the positive electrode mixture material layer 112 and the portion where the positive electrode mixture material layer 112 is arranged is slightly curved, the undulated form may be shaped so that the amplitude Am becomes null after reaching the positive electrode mixture material layer 112.

The undulated form may be shaped so that the amplitude Am does not change until reaching a position that is somewhat close to the negative electrode mixture layer 102 and so that the amplitude Am suddenly becomes null at the position that is somewhat close to the negative electrode mixture layer 102. Further, the undulated form may be shaped so that the amplitude Am does not change until reaching a position that is somewhat close to the positive electrode mixture material layer 112 and so that the amplitude Am suddenly becomes null at the position that is somewhat close to the positive electrode mixture material layer 112. Further, the undulated form may be a portion where the amplitude Am increases as the negative electrode mixture layer 102 or the positive electrode mixture material layer 112 becomes closer.

The amplitude Am may change in the roll 20 from where the rolling is initiated to where the rolling is terminated. For example, the amplitude Am may differ in the roll 20 between the rolling initiating portion and the rolling terminating portion. Alternatively, in at least one section between the rolling initiating portion and the rolling terminating portion, parts where the amplitude Am is large and parts where the amplitude Am is small may be arranged alternately. The amplitude Am may change in an irregular manner in at least one section between the rolling initiating portion and the rolling terminating portion of the roll 20.

The wavelength 2 may change in the roll 20 between the rolling initiating portion and the rolling terminating portion. For example, the wavelength 2 may differ in the roll 20 between the rolling initiating portion and the rolling terminating portion. Alternatively, in at least one section between the rolling initiating portion and the rolling terminating portion, parts where the wavelength 2 is large and parts where the wavelength 2 is small may be arranged alternately. The wavelength 2 may change in an irregular manner in at least one section between the rolling initiating portion and the rolling terminating portion of the roll 20.

In the present embodiment, the wavelength 2 is the same at a position close to the negative electrode mixture layer 102 and a position far from the negative electrode mixture layer 102, and the wavelength 2 is the same at a position close to the positive electrode mixture material layer 112 and a position far from the positive electrode mixture material layer 112. Further, the waveform phase is the same in the undulated form at a position close to the negative electrode mixture layer 102 and a position far from the negative electrode mixture layer 102, and the waveform phase is the same in the undulated form at a position close to the positive electrode mixture material layer 112 and a position far from the positive electrode mixture material layer 112.

The waveform phase in the undulated form may differ between a position close to the negative electrode mixture layer 102 and a position far from the negative electrode mixture layer 102. Further, the waveform phase in the undulated form may differ between a position close to the positive electrode mixture material layer 112 and a position close to the positive electrode mixture material layer 112.

The waveform phase in the undulated form may be the same in two adjacent ones of the negative electrode substrate layers 101 or be different like in the present embodiment. Further, the waveform phase in the undulated form may be the same in two adjacent ones of the positive electrode substrate layers 111 or be different like in the present embodiment.

Regardless of whether the waveform phase in the undulated form is the same or different in two adjacent ones of the negative electrode substrate layers 101, at least part of the surfaces of the two negative electrode substrate layers 101 may be in contact. Further, regardless of whether the waveform phase in the undulated form is the same or different in two adjacent ones of the positive electrode substrate layers 111, at least part of the surfaces of the two positive electrode substrate layers 111 may be in contact.

When the undulated form differs even slightly between two adjacent ones of the negative electrode substrate layers 101, the dimension of the gap Δ between the two negative electrode substrate layers 101 changes in accordance with position. Further, when the undulated form differs even slightly between two adjacent ones of the positive electrode substrate layers 111, the dimension of the gap Δ between the two positive electrode substrate layers 111 changes in accordance with position. This results in the dimension of the gap Δ being large at certain locations, and the dimension of the gap Δ being small at other locations. Movement of the electrolyte 27 is hindered at a position where the dimension of the gap Δ is small

The undulated form may be shaped like in the present embodiment so that the crests 31 and the troughs 32 are alternately arranged in the surfaces of the substrate layers 101 and 111 without substantially changing the thicknesses of the substrate layers 101 and 111. The substrate layers 101 and 111 may have the form of a combined wave combining two or more waves without substantially changing thickness. Further, the crests 31 and the troughs 32 may be arranged in an irregular manner without substantially changing the thicknesses of the substrate layers 101 and 111.

A method for manufacturing the lithium-ion battery 11 in accordance with the present embodiment will now be described.

Outline of Process for Producing Electrode Plate

As shown in FIG. 8, in a method for manufacturing the lithium-ion battery 11, a process for producing an electrode plate is first performed. The electrode plate producing process includes an applying step of applying mixture layers 102 and 112 to the electrode plate, a drying step of drying the mixture layers 102 and 112, a pressing step of pressing and adjusting the thickness of electrode plate, and a slitting step of slitting the electrode plate.

In step 5201, the applying step is performed. A paste formed by mixing an active material, a conductive material, and a binder is thinly applied to central portions, with respect to the widthwise direction X, in the two opposite surfaces of the negative electrode substrate layer 101, which serves as an electrode plate, and the positive electrode substrate layer 111, which serves as an electrode plate. This results in portions that are free from the mixture layers 102 and 112 being formed at the two ends of the strips of the substrate layers 101 and 111 in the widthwise direction X. In other words, in the applying step, the uncoated portion UCP, which is where the mixture layers 102 and 112 are not applied, are formed at the two sides of the coated portion CP, which is where the mixture layers 102 and 112 are applied, in the widthwise direction X.

The paste for a negative electrode and the paste for a positive electrode differ in composition. The negative electrode paste is applied to the negative electrode substrate layer 101 to form the negative electrode mixture layer 102, and the positive electrode paste is applied to the positive electrode substrate layer 111 to form the positive electrode mixture material layer 112. The applied paste is adjusted to a predetermined thickness by a roller or doctor blade.

In step S202, the drying step is performed. An infrared drying device, for example, volatilizes the solvent of the binder so as to harden the applied paste to a certain extent.

In step S203, the pressing step is performed. The negative electrode substrate layer 101, to which the negative electrode mixture layers 102 are applied, are pressed from two sides by two pressing rollers while moved relative to the pressing rollers from one end to the other end in the longitudinal direction Z. This flattens the negative electrode mixture layer 102 and adjusts the thickness of the portion where the negative electrode mixture layer 102 is applied to a predetermined thickness. Further, the positive electrode substrate layer 111, to which the positive electrode mixture material layer 112 is applied, is pressed from two sides by two pressing rollers while moved relative to the pressing rollers from one end to the other end in the longitudinal direction Z. This flattens the positive electrode mixture material layer 112 and adjusts the thickness of the portion where the positive electrode mixture material layer 112 is applied to a predetermined thickness.

In step 5204, the slitting step is performed. The negative electrode substrate layer 101, to which the negative electrode mixture layer 102 is applied, is slit in the longitudinal direction Z at a central position in the widthwise direction X of the negative electrode mixture layer 102. This obtains two strips of the negative electrode plates 100, which serve as electrode plates. Further, the positive electrode substrate layer 111, to which the positive electrode mixture material layer 112 is applied, is slit in the longitudinal direction Z at a central position in the widthwise direction X of the positive electrode mixture material layer 112. This obtains two strips of the positive electrode plate 110, which serve as electrode plates.

In a rolling step, which will be described later, a stack of the negative electrode plate 100 and the positive electrode plate 110, which are produced in this process, and a strip of the separator 120, is rolled in the rolling direction Z and flattened to form the roll 20.

The slitting step may be omitted. In this case, the dimension of the substrate layers 101 and 111 in the widthwise direction X is reduced by substantially one-half so that the applying step results in the uncoated portion UCP being formed at only one end in the widthwise direction X. This allows the negative electrode plate 100 and the positive electrode plate 110 to be produced without the slitting step being performed.

Outline of Cell Assembling Process

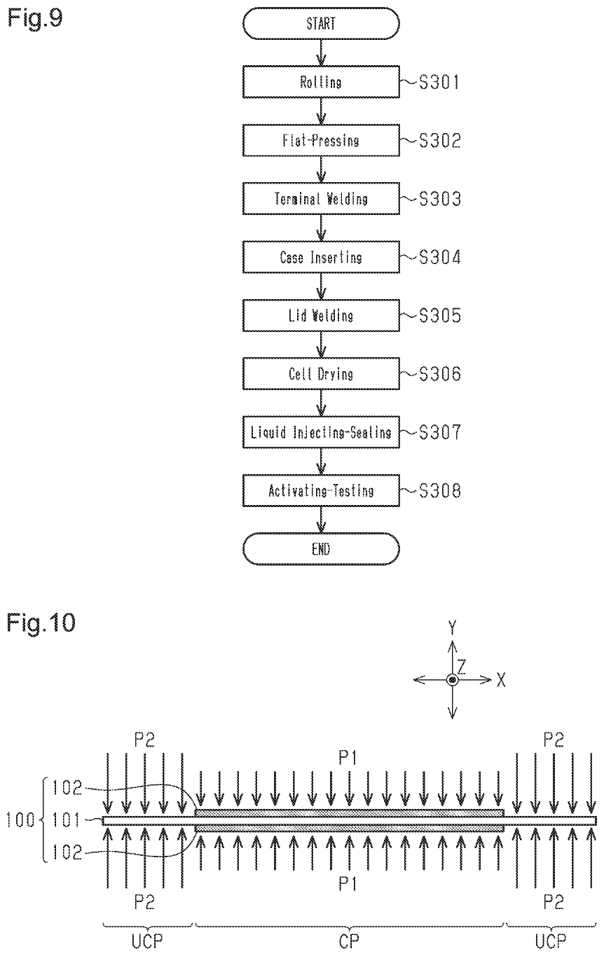

As shown in FIG. 9, a process for assembling the cell is performed when manufacturing the lithium-ion battery 11. The cell assembling process includes a rolling step, a flat-pressing step, a terminal welding step, a case inserting step, a lid welding step, a cell drying step, a liquid injecting-sealing step, and an activating-testing step.

In step 5301, the rolling step is performed. A stack of the negative electrode plate 100 and the positive electrode plate 110, which are produced as illustrated in the flowchart of FIG. 8, and the strip of the separator 120 is rolled in the rolling direction Z to form the roll 20. Tension T in the longitudinal direction Z is applied to each of the negative electrode plate 100, the positive electrode plate 110, and the separator 120 when rolled to form the roll 20. More specifically, the negative electrode plate 100, which is an electrode plate, the separator 120, and the positive electrode plate 110, which is an electrode plate, are stacked together and then rolled to form the roll 20.

In step S302, the flat-pressing step is performed. More specifically, the roll 20 is pressed and shaped in the thickness direction Y, which is a direction orthogonal to the axial direction X when rolling the stack in the rolling step. The roll 20 is flatly shaped to form the roll 20 with the flattened form. In other words, the flat portion F is formed on two opposite sides of the roll 20, which has a flattened form, in the thickness direction Y of the roll 20.

In step S303, the terminal welding step is performed. Collector terminals are attached to the roll 20. More specifically, the negative electrode collector 23 is welded to one end of the roll 20 in the axial direction X, and the positive electrode collector 25 is welded to the other end of the roll 20 in the axial direction X. This connects the roll 20 to the negative electrode external terminal 24 and the positive electrode external terminal 26.

In step S304, the case inserting step is performed. The roll 20, to which an insulation film is applied, is inserted into the battery case 21.

In step S305, the lid welding step is performed. The lid 22 is laser-welded to the battery case 21.

In step S306, the cell drying step is performed. The roll 20 is heated to remove moisture.

In step S307, the liquid injecting-sealing step is performed. The electrolyte 27 is injected into the battery case 21 from a liquid port. Then, the liquid port is sealed.

In step 5308, the activating-testing step is performed. Conditioning, aging, and testing are performed to complete the cell battery.

Process for Obtaining Undulated Form

As shown in FIG. 10, in the pressing step of step 5203, the negative electrode plate 100 is moved so that pressures P1 and P2 are applied to the opposite surfaces of the negative electrode plate 100 in the thickness direction Y from one end to the other end in the longitudinal direction Z. In other words, the negative electrode plate 100 is relatively moved from one end to the other end in the longitudinal direction Z while the pressures P1 and P2 are applied to the opposite surfaces of the negative electrode plate 100 in the thickness direction Y. The first pressure P1 is applied to the coated portion CP from two sides in the thickness direction Y. The second pressure P2 is applied to the uncoated portion UCP from two sides in the thickness direction Y.

This adjusts the thickness of the coated portion CP to a predetermined thickness. Application of the first pressure P1 to the coated portion CP decreases the dimension in the thickness direction Y and increases the dimension in the longitudinal direction Z. That is, the coated portion CP is reduced in thickness, and the coated portion CP is elongated in the longitudinal direction Z. More specifically, the negative electrode substrate layer 101 and the negative electrode mixture layer 102 forming the coated portion CP are both decreased in dimension in the thickness direction Y and increased in dimension in the longitudinal direction Z.

Further, application of the second pressure P2 to the uncoated portion UCP decreases the dimension in the thickness direction Y and increases the dimension in the longitudinal direction Z. That is, the uncoated portion UCP is reduced in thickness, and the uncoated portion CP is elongated in the longitudinal direction Z. More specifically, the uncoated portion UCP is formed by only the negative electrode substrate layer 101. Thus, the negative electrode substrate layer 101 forming the uncoated portion UCP is reduced in dimension in the thickness direction Y and increased in dimension in the longitudinal direction Z.

In the pressing step, the value of the first pressure P1 applied to the coated portion CP and the value of the second pressure P2 applied to the uncoated portion UCP are set so that the elongated amount of the uncoated portion UCP in the longitudinal direction Z is greater than the elongated amount of the coated portion CP in the longitudinal direction Z. The value of the second pressure P2 applied to the uncoated portion UCP is set to be greater than the value of the first pressure P1 applied to the coated portion CP.

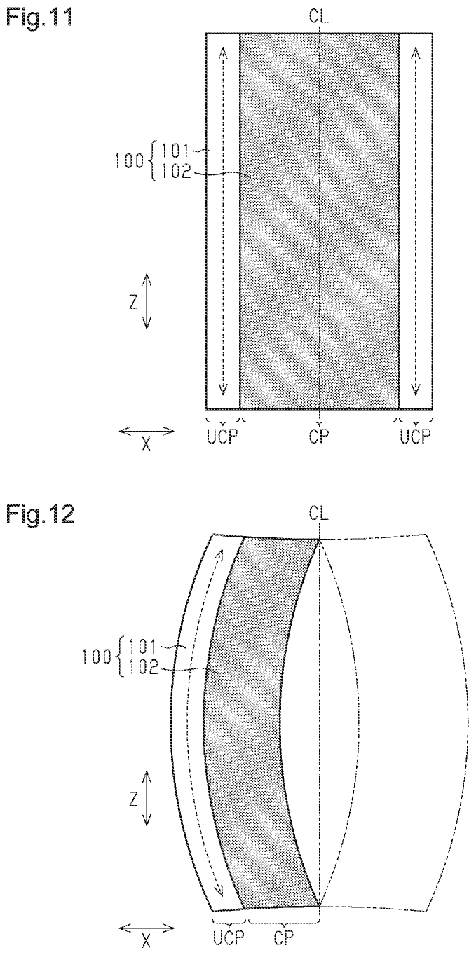

As shown in FIG. 11, the state of the negative electrode plate 100 subsequent to the pressing step is such that the elongated amount of the uncoated portion UCP in the longitudinal direction Z is greater than the elongated amount of the coated portion CP in the longitudinal direction Z. Thus, there is no change in shape. More specifically, the negative electrode plate 100 includes internal stress acting to deform the uncoated portion UCP in the longitudinal direction Z as shown by the broken-line arrows in FIG. 11. However, the coated portion CP, located in the central portion with respect to the widthwise direction X, limits deformation of the uncoated portion UCP in the longitudinal direction Z. Further, in the pressing step, the pressing step is performed at a portion where the negative electrode plate 100 rolled in the longitudinal direction Z is unrolled, and the negative electrode plate 100 subsequent to the pressing step is rolled again in the longitudinal direction Z. This completes the pressing step. Thus, in the pressing step, the negative electrode plate 100 is in a state rolled in the longitudinal direction Z. This limits deformation at the uncoated portion UCP in the longitudinal direction Z. That is, subsequent to the pressing step, the negative electrode plate 100 is still substantially rectangular, and the negative electrode plate 100 includes internal stress acting to deform the uncoated portion UCP in the longitudinal direction Z.

As shown in FIG. 12, in the slitting step of step S204, the negative electrode plate 100 of FIG. 11 is slit along a slit line CL. This forms two strips of negative electrode plates 100 that are gently arched as shown in FIG. 12. In other words, the negative electrode plate 100 is slit at the central position of the coated portion CP to release the internal stress shown by the broken-line arrows in FIG. 12 and allow the uncoated portion UCP to be stretched in the longitudinal direction Z. In the negative electrode plate 100 subsequent to the slitting step, the elongated amount of the uncoated portion UCP in the longitudinal direction Z is greater than the elongated amount of the coated portion CP in the longitudinal direction Z. To deform the negative electrode plate 100 to such a shape, the value of the second pressure P2 applied to the uncoated portion UCP is set to be greater than the value of the first pressure P1 applied to the coated portion CP in the pressing step.

As described above, the dimension of the strip of the negative electrode substrate layer 101 in the widthwise direction X is reduced by substantially one-half so that the applying step results in the uncoated portion UCP being formed at only one end in the widthwise direction X. This allows the negative electrode plate 100 to be produced without performing the slitting step to be identical in shape to the negative electrode plate 100 produced by performing the slitting step. In this case, the negative electrode plate 100 subsequent to the pressing step is identical in shape to the negative electrode plate 100 shown in FIG. 12.

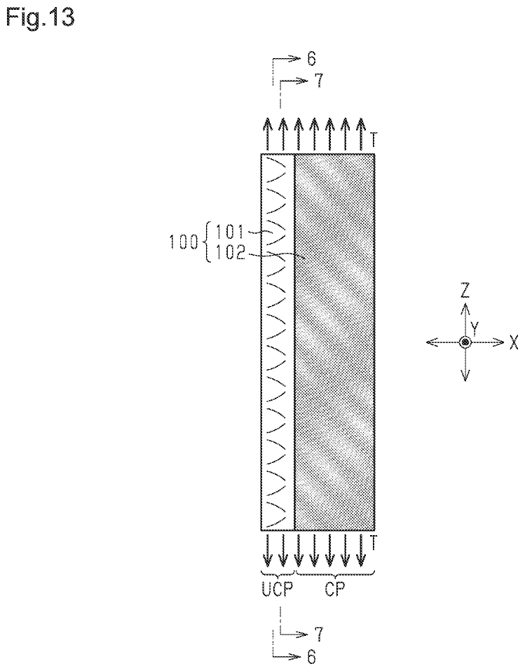

As shown in FIG. 13, in the rolling step of step S301, the roll 20 is formed to correct the shape of the negative electrode plate 100 so that the negative electrode plate 100 is substantially rectangular in a plan view taken in the thickness direction Y. More specifically, in the rolling step, with respect to the negative electrode plate 100, the tension T applied in the longitudinal direction Z to the negative electrode plate 100 when forming the roll 20 is set so that the length of the uncoated portion UCP in the longitudinal direction Z becomes the same as the length of the coated portion CP in the longitudinal direction Z

Tension T acts to correct and straighten the negative electrode plate 100 in shape in a plan view taken in the thickness direction Y. The slitting step following the pressing step stretches and increases the length of the coated portion CP in the longitudinal direction Z during. Thus, the coated portion CP cannot be further increased in length in the longitudinal direction Z. For this reason, the uncoated portion UCP is decreased in length in the longitudinal direction Z to correct the shape of the negative electrode plate 100. More specifically, the negative electrode substrate layer 101 at the uncoated portion UCP is not decreased in length. The negative electrode substrate layer 101 at the uncoated portion UCP is deformed to have undulated form so that the length of the uncoated portion UCP of the negative electrode substrate layer 101 in the longitudinal direction Z becomes the same as the length of the coated portion CP in the longitudinal direction Z. Further, the undulated form is formed in the uncoated portion UCP so that the amplitude Am decreases as the negative electrode mixture layer 102 or the positive electrode mixture material layer 112 becomes closer and so that the amplitude Am increases as the negative electrode mixture layer 102 or the positive electrode mixture material layer 112 becomes farther.

In this manner, the undulated form is formed in the negative electrode collector portion 103. The positive electrode collector portion 113 is formed through a similar manufacturing method and includes a similar undulated form. In the pressing step, the value of the first pressure P1 applied to the coated portion CP and the value of the second pressure P2 applied to the uncoated portion UCP are set so that the elongated amount of the uncoated portion UCP in the longitudinal direction Z is greater than the elongated amount of the coated portion CP in the longitudinal direction Z. In the rolling step, the tension T applied to the positive electrode plate 110 when forming the roll 20 is set so that the length of the uncoated portion UCP in the longitudinal direction Z becomes the same as the length of the coated portion CP in the longitudinal direction Z in the positive electrode plate 110.

### Operation of Embodiment

The operation of the present embodiment will now be described.

The roll 20, which has a flattened form, expands and contracts in the axial direction X during charging and discharging. This produces a force that acts to move the electrolyte 27 in the axial direction X of the roll 20. The negative electrode collector portion 103 and the positive electrode collector portion 113, however, each include the undulated form. Thus, the crests 31 of the undulated form shown in FIG. 5 interfere with the flow of the electrolyte 27 shown by the solid-line arrows in FIG. 5. In other words, the resistance produced when the electrolyte 27 moves in the axial direction X of the roll 20 increases and hinders movement of the electrolyte 27 in the axial direction X of the roll 20.

The undulated form of the negative electrode collector portion 103 is shaped so that the amplitude Am decreases as the negative electrode mixture layer 102 becomes closer and so that the amplitude Am increases as the negative electrode mixture layer 102 becomes farther. With such an undulated form, movement of the electrolyte 27 toward the end of the roll 20 can be hindered while keeping the central portion of the negative electrode substrate layer 101 flat. Further, the undulated form of the positive electrode collector portion 113 is shaped so that the amplitude Am decreases as the positive electrode mixture material layer 112 becomes closer and so that the amplitude Am increases as the positive electrode mixture material layer 112 becomes farther. With such an undulated form, movement of the electrolyte 27 toward the end of the roll 20 can be hindered while keeping the central portion of the positive electrode substrate layer 111 flat.

The manufacturing method described above facilitates the shaping of the undulated form that decreases the amplitude Am as the negative electrode mixture layer 102 or the positive electrode mixture material layer 112 becomes closer and increases the amplitude Am as the negative electrode mixture layer 102 or the positive electrode mixture material layer 112 becomes farther.

The area near the middle of the negative electrode collector portion 103 is connected to the negative electrode external terminal 24 and the connector 23a. This results in the dimension of the gap Δ above the roll 20 being substantially null. The area near the middle of the positive electrode collector portion 113 is connected to the positive electrode external terminal 26 and the connector 25a. This results in the dimension of the gap Δ above the roll 20 being substantially null. Thus, the electrolyte 27 enters and exits the end of the roll 20 that is located at the lower part of the roll 20. The negative electrode collector portion 103 includes the undulated form that is located below the lower end 23b of the connector 23a. This decreases the entrance and exit of the electrolyte 27 that occurs in the negative electrode collector portion 103 at the lower part of the roll 20. Further, the positive electrode collector portion 113 includes the undulated form that is located below the lower end 25b of the connector 25a. This decreases the entrance and exit of the electrolyte 27 that occurs in the positive electrode collector portion 113 at the lower part of the roll 20.

Expansion and contraction in the axial direction X of the roll 20 produces a force that acts to move the electrolyte 27 in each gap Δ in the axial direction X. With the gap Δ between the negative electrode substrate layers 101 in the negative electrode collector portion 103 and the gap Δ between the positive electrode substrate layers 111 in the positive electrode collector portion 113, the gap Δ is located at a position that varies in the thickness direction Y orthogonal to the direction in which the electrolyte 27 moves, namely, the axial direction X. This increases the resistance produced when the electrolyte 27 moves in the axial direction X through the gaps A between the substrate layers 101 and 111 and hinders movement of the electrolyte 27 in the axial direction X.

The undulated forms of the negative electrode plate 100 and the positive electrode plate 110 results in the dimension of the gap Δ being large at certain locations and the dimension of the gap Δ being small at other locations. At locations where the dimension of the gap Δ is small, the resistance produced when the electrolyte 27 moves in the axial direction X through the gaps A between the substrate layers 101 and 111 and hinders movement of the electrolyte 27 in the axial direction X.

The process for shaping the undulated form in the method for manufacturing the lithium-ion battery 11 allows the negative electrode plate 100 to have the undulated form in the negative electrode collector portion 103 of the negative electrode substrate layer 101. Further, the process for shaping the undulated form in the method for manufacturing the lithium-ion battery 11 allows the positive electrode plate 110 to have the undulated form in the positive electrode collector portion 113 of the positive electrode substrate layer 111.

In the pressing step, the value of the first pressure P1 applied to the coated portion CP and the value of the second pressure P2 applied to the uncoated portion UCP are set so that the elongated amount of the uncoated portion UCP in the longitudinal direction Z is greater than the elongated amount of the coated portion CP in the longitudinal direction Z. Thus, in the slitting step following the pressing step, the length of the uncoated portion UCP in the longitudinal direction Z is decreased, and the length of the coated portion CP in the longitudinal direction Z is increased. In the following rolling step, the tension T applied to the negative electrode plate 100 and the positive electrode plate 110 when forming the roll 20 is set so that the length of the uncoated portion UCP in the longitudinal direction Z is the same as the length of the coated portion CP in the longitudinal direction Z. This allows the negative electrode plate 100 and the positive electrode plate 110 that are curved in the slitting step, which follows the pressing step, to have a rectangular shape in a plan view taken in the thickness direction Y. In other words, the rolling step straightens the negative electrode plate 100 and the positive electrode plate 110 in a plan view taken in the thickness direction Y.

### Test Result of Operation of Embodiment

In the lithium-ion battery 11 in accordance with the present embodiment, the internal resistance during high-rate charging and discharging was as follows. When decreasing the area ratio of the gap Δ by 50%, the change rate of the internal resistance in the lithium-ion battery 11 during repeated charging and discharging was decreased by 1.7%. Battery performance deterioration can be suppressed by decreasing the change rate of the internal resistance.

The results described below were obtained when shaping the undulated form through the method for manufacturing the lithium-ion battery 11 in accordance with the present embodiment. When setting the value of the second pressure P2 applied to the uncoated portion UCP to be 1.2 times greater than the value of the first pressure P1 applied to the coated portion CP, the elongated amount of the uncoated portion UCP in the longitudinal direction Z was greater than the elongated amount of the coated portion CP in the longitudinal direction Z in the slitting step following the pressing step. In the following rolling step, tension T was adjusted so as to have the length of the uncoated portion UCP in the longitudinal direction Z become the same as the length of coated portion CP in the longitudinal direction Z. In contrast with when there was no undulated form, the gap Δ included portions where the dimension of the gap Δ was smaller by at least 75%. The change rate of the internal resistance during high-rate charging and discharging is substantially in inverse proportion to the dimension of the gap Δ. In the present embodiment, the undulated form decreased the change rate of the internal resistance during repeated charging and discharging by 2.55%. The dimension of the gap Δ when there was no undulated form was 73 μm, whereas the dimension of the gap Δ was less than or equal to 18 μm in the present embodiment at portions where the dimension of the gap Δ was smaller by at least 75%.

In the pressing step of the method for manufacturing the lithium-ion battery 11 in accordance with the present embodiment, the value of the second pressure P2 applied to the uncoated portion UCP was 1.2 times greater than the value of the first pressure P1 applied to the coated portion CP. The lithium-ion battery 11 in accordance with the present embodiment includes sections in the flat portion F of the flat form of the negative electrode collector portion 103 where the dimension of the gap Δ between two adjacent ones of the negative electrode substrate layers 101 in the thickness direction Y of the negative electrode substrate layer 101 is 18 μm or less. Further, the lithium-ion battery 11 in accordance with the present embodiment includes sections in the flat portion F of the flat form of the positive electrode collector portion 113 where the dimension of the gap Δ between two adjacent ones of the positive electrode substrate layers 111 in the thickness direction Y of the positive electrode substrate layer 111 is 18 μm or less.

### Advantages of Embodiment

The advantages of the present embodiment will now be described.

(1) One of the ends in the axial direction X is free from the negative electrode mixture layer 102, which is applied to the two opposite surfaces of the negative electrode substrate layer 101, and includes the negative electrode collector portion 103 having the undulated form in which the thickness direction Y of the negative electrode substrate layer 101 corresponds to the direction of the amplitude Am and the rolling direction Z corresponds to the direction of the wavelength λ. The other end in the axial direction X is free from the positive electrode mixture material layer 112, which is applied to the two opposite surfaces of the positive electrode substrate layer 111, and includes the positive electrode collector portion 113 having the undulated form in which the thickness direction Y of the positive electrode substrate layer 111 corresponds to the direction of the amplitude Am and the rolling direction Z corresponds to the direction of the wavelength λ. Thus, the crests 31 of the undulated form hinders movement of the electrolyte 27 in the axial direction X of the roll 20. This keeps the electrolyte 27, of which the lithium salt concentration is decreased, in the roll 20. Consequently, variations in the lithium salt concentration are limited in the roll 20. This avoids increases in the internal resistance that would be caused by repeated charging and discharging.

(2) The undulated form is shaped so that the amplitude Am decreases as the negative electrode mixture layer 102 or the positive electrode mixture material layer 112 becomes closer and so that the amplitude Am increases as the negative electrode mixture layer 102 or the positive electrode mixture material layer 112 becomes farther. The shape of the undulated form easily allows the amplitude Am to decrease as the negative electrode mixture layer 102 or the positive electrode mixture material layer 112 becomes closer and the amplitude Am to increase as the negative electrode mixture layer 102 or the positive electrode mixture material layer 112 becomes farther. Thus, the crests 31 of the undulated form, which is easy to shape, keeps the electrolyte 27, of which the lithium salt concentration is decreased, in the roll 20.

(3) The negative electrode collector portion 103 and the positive electrode collector portion 113 are respectively connected by the connectors 23a and 25a to the external terminals 24 and 26 of the lithium-ion battery 11 above the flat portion F of the flattened form. The negative electrode collector portion 103 and the positive electrode collector portion 113 include the undulated forms below the lower ends 23b and 25b of the connectors 23a and 25a, respectively. In the lithium-ion battery 11, this avoids leakage of the electrolyte 27, of which the lithium salt concentration is decreased, from the roll 20 through the lower portion of the roll 20 where the external terminals 24 and 26 are not connected to the connectors 23a and 25a.

(4) In the flat portion F having the flattened form in the negative electrode collector portion 103, two adjacent ones of the negative electrode substrate layers 101 in the thickness direction Y of the negative electrode substrate layer 101 both have the undulated form. As a result, the gap Δ between the two negative electrode substrate layers 101 is located at a position that varies in the thickness direction Y of the negative electrode substrate layer 101. Further, in the flat portion F having the flattened form in the positive electrode collector portion 113, two adjacent ones of the positive electrode substrate layers 111 in the thickness direction Y of the positive electrode substrate layer 111 both have the undulated form. As a result, the gap Δ between the two positive electrode substrate layers 111 is located at a position that varies in the thickness direction Y of the positive electrode substrate layer 111. The position of the gap Δ varies in the thickness direction Y of the negative electrode substrate layer 101 and the positive electrode substrate layer 111. This increases the resistance produced when the electrolyte 27 moves through the gap Δ in the axial direction X of the roll 20. This avoids leakage of the electrolyte 27, of which the lithium salt concentration is decreased, from the roll 20 through the gaps A between the substrate layers 101 and 111.

(5) The flat portion F of the flattened form in the negative electrode collector portion 103 includes sections where the dimension of the gap Δ between two adjacent ones of the negative electrode substrate layers 101 in the thickness direction Y of the negative electrode substrate layer 101 is 18 μm or less. Further, the flat portion F of the flattened form in the positive electrode collector portion 113 includes sections where the dimension of the gap Δ between two adjacent ones of the positive electrode substrate layers 111 in the thickness direction Y of the positive electrode substrate layer 111 is 18 μm or less. This avoids leakage of the electrolyte 27, of which the lithium salt concentration is decreased, from the roll 20 through the gaps A between the substrate layers 101 and 111 where the dimensions of the gaps A between the substrate layers 101 and 111 are 18 μm or less.

(6) The applying step forms the uncoated portion UCP, which is where the mixture layers 102 and 112 are not applied, at one or two sides of the coated portion CP, which is where the mixture layers 102 and 112 are applied, in the widthwise direction X. In the pressing step, the value of the first pressure P1 applied to the coated portion CP and the value of the second pressure P2 applied to the uncoated portion UCP are set so that the elongated amount of the uncoated portion UCP in the longitudinal direction Z is greater than the elongated amount of the coated portion CP in the longitudinal direction Z. Thus, the negative electrode plate 100 and the positive electrode plate 110 having the undulated form that avoids leakage of the electrolyte 27, of which the lithium salt concentration is decreased, from the roll 20 can be arranged in the collector portions 103 and 113 of the substrate layers 101 and 111. Further, the negative electrode plate 100 and the positive electrode plate 110 having the undulated form can be used to form the roll 20 and manufacture the lithium-ion battery 11.

(7) In the rolling step, in the negative electrode plate 100 and the positive electrode plate 110, the length of the uncoated portion UCP in the longitudinal direction Z is the same as the length of the coated portion CP in the longitudinal direction Z. The tension T applied to the negative electrode plate 100 and the positive electrode plate 110 is set to obtain such length when forming the roll 20. This allows the negative electrode plate 100 and the positive electrode plate 110 to have a rectangular shape in a plan view taken in the thickness direction Y. Here, the negative electrode plate 100 and the positive electrode plate 110 were curved in the slitting step following the pressing step. Further, the roll 20 that is free from distortion are formed with the negative electrode plate 100 and the positive electrode plate 110 having the undulated form in the collector portions 103 and 113 of the substrate layers 101 and 111 to manufacture the lithium-ion battery 11.

(8) In the pressing step, the value of the second pressure P2 applied to the uncoated portion UCP is 1.2 time greater than the value of the first pressure P1 applied to the coated portion CP. This allows the roll 20 to be formed with the negative electrode plate 100 and the positive electrode plate 110 that effectively avoid leakage of the electrolyte 27, of which the lithium salt concentration is decreased, from the roll 20 at the collector portions 103 and 113 of the substrate layers 101 and 111.

### Modified Examples of Present Embodiment

The present embodiment may be modified as described below. The present embodiment and the following modifications can be combined as long as there is no technical contradiction.

In the present embodiment, although the negative electrode mixture layer 102 is applied to both sides of the negative electrode substrate layer 101, the negative electrode mixture layer 102 may be applied to only one side of the negative electrode substrate layer 101. In the same manner, in the present embodiment, although the positive electrode mixture material layer 112 is applied to both sides of the positive electrode substrate layer 111, the positive electrode mixture material layer 112 may be applied to only one side of the positive electrode substrate layer 111.

The undulated form is not limited to the shape described through the manufacturing method illustrated in the present embodiment. For example, sections of the collector portions 103 and 113 can be pressed from opposite sides in the thickness direction Y by a concave press and a convex press to form the undulated form in the collector portions 103 and 113. The pressed sections can be arranged at irregular intervals in the widthwise direction X or the longitudinal direction Z. The collector portions 103 and 113 only needs to include the crests 31 shaped to hinder the flow of the electrolyte 27 in the axial direction X. Further, for example, the undulated form can be formed by pressing the collector portions 103 and 113 from two sides with two rollers having undulated shaping surfaces and moving the rollers relative to the collector portions 103 and 113 from one end to the other end in the longitudinal direction Z.

In the flat portion F of the flattened form of the roll 20, the collector portions 103 and 113 do not need to include the crests 31 at the side ends in the widthwise direction X as long as crests 31 shaped to hinder the flow of the electrolyte 27 in the axial direction X are arranged between the side ends and the mixture layers 102 and 112. The collector portions 103 and 113 only need to include the crests 31 shaped to hinder the flow of the electrolyte 27 in the axial direction X.

Prior to the rolling step, a correcting step that corrects the shape of the negative electrode plate 100 can be performed by applying tension T in the longitudinal direction Z of the negative electrode plate 100 so that the negative electrode plate 100 is substantially rectangular in a plan view taken in the thickness direction Y. The rolling step may be performed after the correcting step. More specifically, in the correcting step, with respect to the negative electrode plate 100, the tension T applied to the negative electrode plate 100 is set so that the length of the uncoated portion UCP in the longitudinal direction Z becomes the same as the length of the coated portion CP in the longitudinal direction Z. The correcting step may be performed in the same manner on the positive electrode plate 110.

In the rolling step, the tension applied to the coated portion CP may be greater than the tension applied to the uncoated portion UCP to straightly correct the shape of the negative electrode plate 100 in a plan view taken in the thickness direction Y. With respect to the positive electrode plate 110, the shape of the positive electrode plate 110 may be straightly corrected in a plan view taken in the thickness direction Y.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A lithium-ion battery, comprising:
a roll forming an electrode body, wherein:
the roll includes:
a negative electrode plate including a negative electrode substrate layer that is a substrate of a negative electrode and a negative electrode mixture layer arranged on the negative electrode substrate layer,
a positive electrode plate including a positive electrode substrate layer that is a substrate of a positive electrode and a positive electrode mixture layer arranged on the positive electrode substrate layer, and
a separator arranged between the negative electrode plate and the positive electrode plate;
the roll is formed by rolling a stack of the negative electrode plate, the separator, and the positive electrode plate in a rolling direction;
the roll is pressed in a direction orthogonal to an axial direction when rolled to be shaped in a flattened form;
the roll further includes:
a negative electrode collector portion at one end of the roll in the axial direction where the negative electrode mixture layer is not applied to two opposite surfaces of the negative electrode substrate layer, the negative electrode collector portion having an undulated form in which a thickness direction of the negative electrode substrate layer corresponds to an amplitude direction and the rolling direction corresponds to a wavelength direction, and
a positive electrode collector portion at the other end of the roll in the axial direction where the positive electrode mixture layer is not applied to two opposite surfaces of the positive electrode substrate layer, the positive electrode collector portion having an undulated form in which a thickness direction of the positive electrode substrate layer corresponds to an amplitude direction and the rolling direction corresponds to a wavelength direction.

2. The lithium-ion battery according to claim 1, wherein:
the undulated form is shaped to have an amplitude that decreases as the negative electrode mixture layer or the positive electrode mixture layer becomes closer; and
the undulated form is shaped to have an amplitude that increases as the negative electrode mixture layer or the positive electrode mixture layer becomes farther.

3. The lithium-ion battery according to claim 1, wherein:
the negative electrode collector portion and the positive electrode collector portion are connected by a connector to an external terminal of the lithium-ion battery above a flat portion of the flattened form; and
the undulated form of each of the negative electrode collector portion and the positive electrode collector portion are located downward from a lower end of the connector.

4. The lithium-ion battery according to claim 1, wherein:
in a flat portion of the flattened form of the negative electrode collector portion, two negative electrode substrate layers that are adjacent to each other in a thickness direction of the negative electrode substrate layer of the roll both have the undulated form so that a gap between the two negative electrode substrate layers is located at a position that varies in the thickness direction of the negative electrode substrate layer; and
in a flat portion of the flattened form of the positive electrode collector portion, two positive electrode substrate layers that are adjacent to each other in a thickness direction of the positive electrode substrate layer of the roll both have the undulated form so that a gap between the two positive electrode substrate layers is located at a position that varies in the thickness direction of the positive electrode substrate layer.

5. The lithium-ion battery according to claim 1, wherein:
in a flat portion of the flattened form of the negative electrode collector portion, a gap between two negative electrode substrate layers that are adjacent to each other in a thickness direction of the negative electrode substrate layer of the roll has a dimension of 18 μm or less extends at a certain location between the two negative electrode substrate layers; and
in a flat portion of the flattened form of the positive electrode collector portion, a gap between two positive electrode substrate layers that are adjacent to each other in a thickness direction of the positive electrode substrate layer of the roll has a dimension of 18 μm or less extends at a certain location between the two positive electrode substrate layers.

6. A method for manufacturing a lithium-ion battery, the method comprising:
applying a mixture layer to an electrode plate;
drying the mixture layer;
pressing the electrode plate to adjust a thickness of the electrode plate;
rolling a stack of a negative electrode plate that is the electrode plate, a separator, and a positive electrode plate that is the electrode plate to form a roll; and
flat-pressing the roll in a direction orthogonal to an axial direction in which the rolling is performed so as to press and shape the roll, wherein
the applying a mixture layer includes forming an uncoated portion where the mixture layer is not applied at one or two widthwise ends of a coated portion where the mixture layer is applied, and
the pressing the electrode plate includes setting a value of a first pressure applied to the coated portion and a value of a second pressure applied to the uncoated portion so that an elongated amount of the uncoated portion in a longitudinal direction becomes greater than an elongated amount of the coated portion in the longitudinal direction.

7. The method according to claim 6, wherein:
the rolling a stack includes setting tension applied to the negative electrode plate and the positive electrode plate when forming the roll so that the uncoated portion and the coated portion have the same lengths in a longitudinal direction.

8. The method according to claim 6, wherein in the pressing the electrode plate, the value of the second pressure applied to the uncoated portion value is 1.2 times greater than the value of the first pressure applied to the coated portion.
